(19) United States
(12) Patent Application Publication
(10) Pub. No.: US 2007/0127571 A1
(43) Pub. Date: Jun. 7, 2007

(54) IMAGE PROCESSING APPARATUS AND METHOD

(75) Inventor: JUN MAKINO, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/548,392

(22) Filed: Oct. 11, 2006

(30) Foreign Application Priority Data
Oct. 19, 2005 (JP) 2005-304583

(51) Int. Cl. H04N 11/04; H04N 7/12

(52) U.S. Cl. 375/240.13; 375/240.26

(57) ABSTRACT

I and P pictures are encoded in the order of the frames of image data by referring to reference pictures. After the I and P pictures are encoded, B pictures between the I and P pictures or between the P pictures are encoded by referring to the reference pictures. Whether B pictures obtained by decoding B pictures thus encoded are to be used as reference pictures is changed over by a B picture selector during the encoding of the image data.

### BACKGROUND OF THE INVENTION

1. Field of the Invention

The present invention relates to an image processing apparatus and method for encoding and compressing image data.

2. Description of the Related Art

A variety of schemes for compressing and recording image data have been proposed heretofore. A new scheme referred to as MPEG4 part-10: AVC (ISO/IEC 14496-10, referred to also as H.264) has been proposed (this scheme will be referred to as H.264 below).

FIG. 6 is a diagram useful in describing a compression procedure according to H.264.

Image data that has been input to the system is divided into macroblocks and a subtractor 601 finds the difference between the input and a predicted value. The difference is subjected to an integer DCT (Discrete Cosine Transform) in a DCT unit 602 and is then quantized by a quantizer 603. The result of quantization is sent to an entropy encoder 615 as residual image data. The result of quantization is also subjected to inverse quantization by an inverse quantizer (dequantizer) 604 and then to an inverse integer DCT by an inverse integer DCT unit 605. The predicted value is added to the output of the inverse DCT unit 605 by an adder 606 to thereby reconstruct the image. The image data thus restored is sent to and stored in a frame memory 607 for intraframe prediction. The image data thus reconstructed is also subjected to deblocking filtering by a filter 609, after which the data is sent to a frame memory 610 for interframe prediction.

The image data for intraframe prediction in the frame memory 607 is used in intraframe prediction performed by an intraframe prediction unit 608. In intraframe prediction, the values of neighboring pixels of already encoded blocks in the same picture are used in making predictions. On the other hand, as will be described later, the image data for interframe prediction in the frame memory 610 is composed of a plurality of pictures and the pictures are divided into two lists, namely List 0 and List 1. This image data is used in an interframe prediction unit 611. Image data predicted in the interframe prediction unit 611 is stored in the frame memory 610 by a memory controller 613, thereby updating the image data in the frame memory 610. Interframe prediction is performed in the interframe prediction unit 611. Specifically, different image data from frame to frame is subjected to motion detection by a motion estimation unit 612, which proceeds to find the optimum motion vector. The optimum motion vector is applied to the interframe prediction unit 611, which then decides the predicted image data.

Optimum predicted data is selected by a switch 614 from within the image data that results from intraframe and interframe predictions. The result from the side of the intraframe prediction or the prediction vector is sent to the entropy encoder 615 and encoded together with the residual image data so that an output bit stream is formed.

Interframe prediction according to H.264 will be described in detail with reference to FIGS. 7, 9, 10 and 11.

In interframe prediction according to H.264, a plurality of pictures can be used in prediction. To achieve this, two lists (List 0 and List 1) are prepared in order to specify reference pictures. It is so arranged that a maximum of five reference pictures are assigned to each list.

There are P pictures, B pictures and I pictures. In the case of a P picture, primarily a forward prediction is performed using only List 0. In the case of a B picture, a bidirectional prediction (or only a forward or backward prediction) is performed using List 0 and List 1. That is, pictures for a forward prediction are mainly assigned to List 0, while pictures for a backward prediction are mainly assigned to List 1.

FIG. 7 is a diagram illustrating the order of display and the order of encoding of the pictures. As for the ratio of the I, P and B pictures, a case will be described where there is a standard I picture at intervals of 16 frames, a P picture at intervals of four frames and B pictures in the three frames between the I and P pictures or between the P pictures.

In FIG. 7, reference numeral 701 denotes image data arrayed in the order of display. Written in each box is a number indicating the type of picture and the order in which it is displayed. For example, I00 represents an I picture that is 0^{th} in the order of display. Here only intraframe prediction is performed. Further, P04 represents a P picture that is fourth in the order of display, and here only a forward prediction is performed; and B01 represents a B picture that is first is the order of display, and here a bidirectional prediction is performed. Accordingly, the order in which encoding is carried out is different from the order of display; encoding is carried out in the order in which prediction is performed. That is, the encoding sequence is as follows, as indicated at 702 in FIG. 7: I00, P04, B01, B02, B03, P08, B05, B06, . . . .

FIG. 8 is a diagram illustrating the relationship between pictures to be encoded and a reference list.

Reference numeral 802 denotes a reference list (List 0). This list contains pictures once they have been encoded and then decoded. For example, in a case where interframe prediction is performed in the picture of P24 (a P picture that is 24^{th} in the order of display), reference is had to pictures in the list already encoded and then decoded. In this example, P04, P08, P12, I16, P20 are contained in the list. In interframe prediction, encoding is performed upon finding, on a per-macroblock basis, a motion vector having the optimum predicted value from within the reference pictures in the list. The pictures in the list are distinguished with the reference picture numbers being put in order (numbers different from those illustrated are given). When the encoding of P24 thus ends, next the P24 is decoded and added to the reference list. The oldest reference picture (here P04) is removed from the reference list. This encoding is thenceforth applied to B21, B22 and B23 and then to P28.

FIG. 9 depicts a view illustrating the manner in which the reference list changes from picture to picture.

FIG. 9 illustrates the pictures undergoing encoding and the content of List 0 and List 1 from top-down in the order of the pictures encoded. In a case that a P picture (or I picture) is encoded, the reference list (List 0 and List 1) is updated and the oldest picture is removed from the reference list, as illustrated in FIG. 9. In this example, List 1 has only one picture. The reason for this is that in a case that many backward references are made, there is an increase in amount of buffering up to decoding and, hence, reference to backward pictures that are too distant is avoided.

In the example illustrated here, the pictures used for reference are I and P pictures, and all I and P pictures are added to the reference list successively. Further, in List 1, the picture used in backward prediction is only a single picture. This is an arrangement of pictures that would usually be used most often and is merely an example that would be used most widely; H.264 itself has a higher degree of freedom in terms of the composition of the reference list. For example, it is not necessary to add all I and P pictures to the reference list, and it is possible to add B pictures to the reference list as well. A long-term reference list confined to a reference list until explicitly specified has also been defined.

FIGS. 10 and 11 are diagrams illustrating the order of encoding and the manner in which a reference list changes in a case where B pictures are added to the reference list.

If B pictures are added to a reference list, it is unnecessary to make an addition to the reference list whenever all B pictures are encoded. A method in which only some B pictures from among consecutive B pictures are added to the reference list has been considered. Illustrated as an example is a case where only the middle B picture from among three consecutive frames of B pictures is added to the reference list. In this case, as illustrated in FIG. 10, the order of encoding is such that after a P picture is encoded, the middle B picture is encoded and then the remaining B pictures are encoded successively. In the example of FIG. 10, after P08 is encoded, B06 is encoded and then B05 and B07 are encoded in the order mentioned. After B06 is encoded, it is added to the reference list.

FIG. 11 is a diagram useful in describing updating of a reference list that conforms to the order of picture encoding. In FIG. 11, the numbers of the pictures are changed from those shown in FIG. 10 but the order of the numbers of the I, P and B pictures corresponds to the order of the pictures shown in FIG. 10.

In FIG. 11, the reference list 0 (List 0) and the reference list 1 (List 1) are updated after P40, P44 are encoded, as indicated at 1100, 1101. The specification of Japanese Patent Application Laid-Open No. 2004-88722 can be mentioned as literature that discloses a technique relating to utilization of B pictures.

Thus, according to H.264, whether or not B pictures are added to a reference list is selectable when encoding processing is executed. In general, since encoding efficiency can be raised more with B pictures, it is better to set many B pictures in order to raise the compression rate. However, if B pictures are merely increased and are not added to the reference list, I and P pictures used in reference will become too distant, in terms of time, from the picture to be encoded. With regard to an image exhibiting a large amount of motion, therefore, it is considered that the arrangement of FIG. 10 in which the middle B picture is added to the reference list makes it easier to perform motion compensation because the time interval between the reference picture and the picture to be encoded is short.

With the H.264 standard, however, how many B pictures are to be used and whether reference is to be had to B pictures have not been decided. That is, whether B pictures are added to a reference list is optional depending upon the images and the purpose of compression. Consequently, whether or not B pictures are to be added to a reference list is set fixedly in dependence upon the image and purpose of compression, and the same setting is used even in a case where the nature of the image changes during the course of encoding. The technique set forth in Japanese Patent Application Laid-Open No. 2004-88722 cited above is the result of devising an encoding sequence with regard to the number of B pictures. It does not, therefore, describe making reference to B pictures.

### SUMMARY OF THE INVENTION

As object of the present invention is to solve the problems of the prior art set forth above.

A feature of the present invention is to so arrange it that whether B pictures are added to reference pictures can be selected, thereby making it possible to perform more efficient image encoding.

According to the present invention, there is provided an image processing apparatus for motion-compensated predictive encoding of image data having a plurality of frames that include I, P and B pictures, comprising:

a first encoder configured to encode the I picture by intraframe prediction;

a second encoder configured to encode the P picture by referring to a reference picture;

a third encoder configured to encode a plurality of the B pictures, which exist between the I and P pictures or between the P pictures, upon referring to the reference picture after the encoding by the first and second encoders;

a decision unit configured to decide whether a picture, which has been obtained by decoding a B picture that was encoded by the third encoder, is to be used as the reference picture during the encoding of the image data; and

an updating unit configured to update the reference picture by the picture obtained by decoding the B picture, in a case that the decision unit decides that the picture obtained by decoding the B picture that was encoded by the third encoder is to be used as the reference picture.

Further according to the present invention, there is provided an image processing method for motion-compensated predictive encoding of image data having a plurality of frames that include I, P and B pictures, comprising:

a first encoding step of encoding the I picture by intraframe prediction;

a second encoding step of encoding the P picture by referring to a reference picture;

a third encoding step of encoding a plurality of the B pictures, which exist between the I and P pictures or between the P pictures, upon referring to the reference picture after the encoding in the first and second encoding steps;

a decision step of deciding whether a picture, which has been obtained by decoding a B picture that was encoded in the third encoding step, is to be used as the reference picture during the encoding of the image data; and

an updating step of updating the reference picture by the picture obtained by decoding the B picture, in a case that it is decided in the decision step that the picture obtained by decoding the B picture that was encoded in the third encoding step is to be used as the reference picture.

Further features of the present invention will become apparent from the following description of an exemplary embodiment with reference to attached drawings.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a functional block diagram useful in describing the structure of an image encoding apparatus according to an embodiment of the present invention;

FIG. 2 is a flowchart for describing the processing of a controller that controls encoding processing by the image encoding apparatus according to this embodiment;

FIG. 3 is a diagram useful in describing a specific example of a case where it is instructed to add B pictures to a reference list during the course of encoding of pictures arrayed in the order in which they are displayed;

FIG. 4 is a diagram illustrating the manner in which a reference list is updated in a case where a change has been made so as to refer to B pictures during the course of encoding;

FIG. 5 is a block diagram for describing the structure of an image sensing apparatus according to this embodiment;

FIG. 6 is a diagram useful in describing a compression procedure compliant with the H.264 scheme;

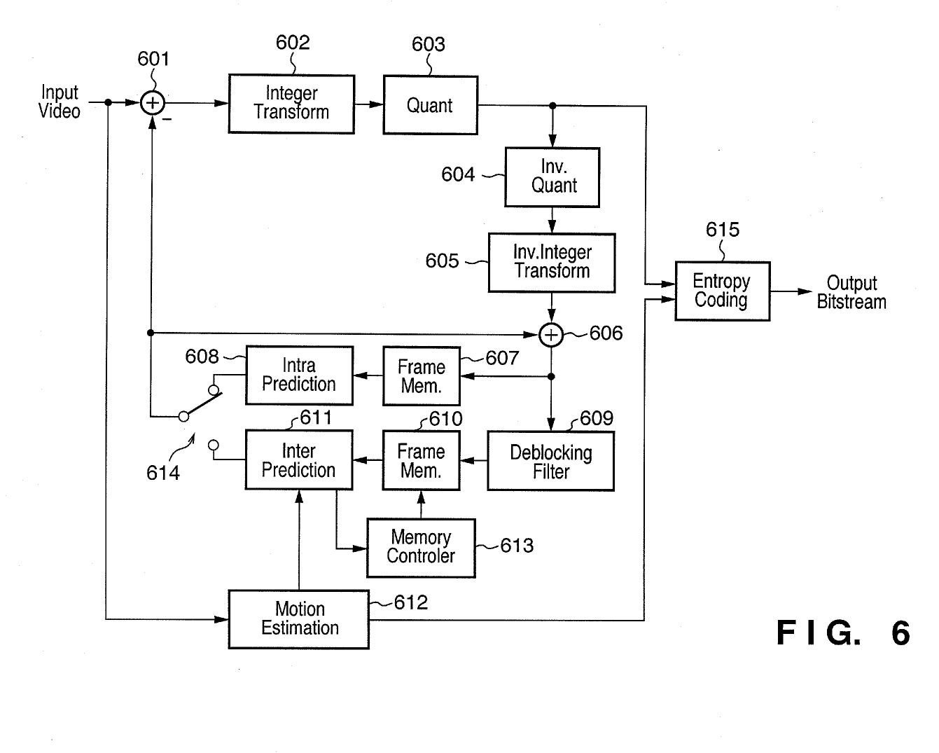

FIG. 7 is a diagram illustrating the order of display and the order of encoding of pictures;

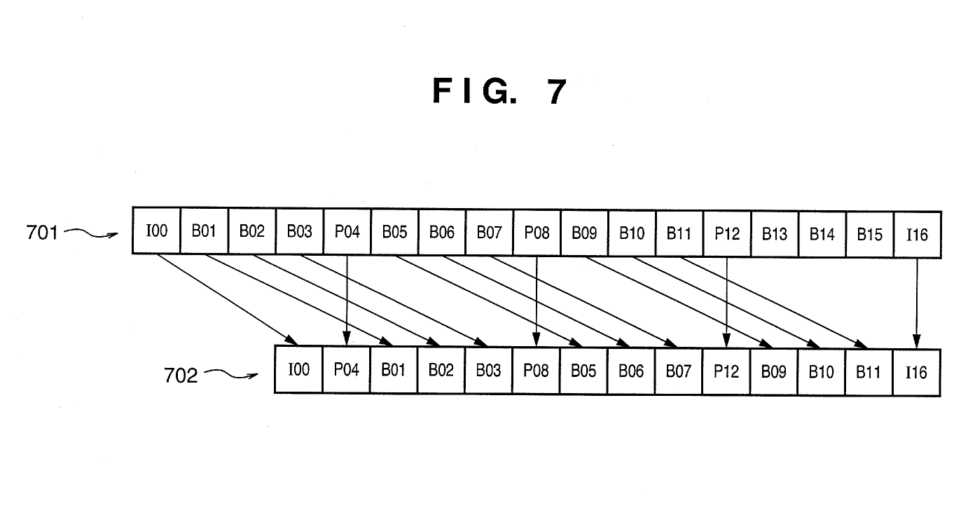

FIG. 8 is a diagram illustrating the relationship between pictures to be encoded and a reference list;

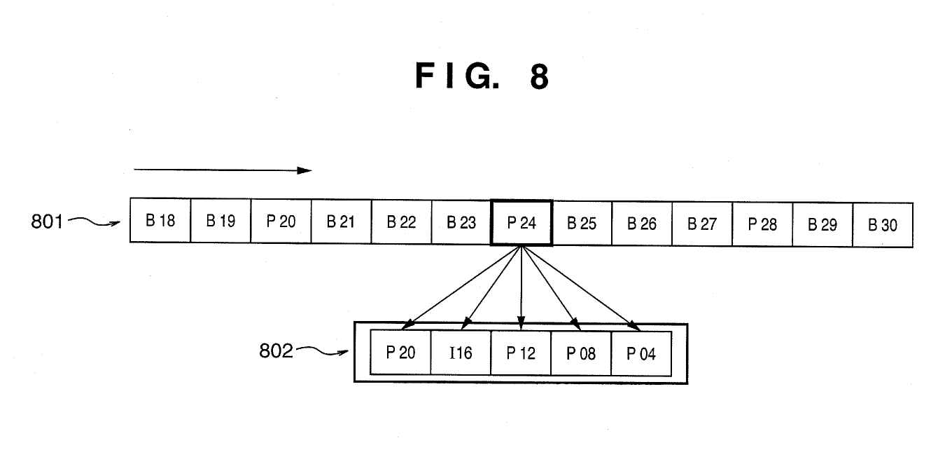

FIG. 9 depicts a view illustrating the manner in which the reference list changes from picture to picture;

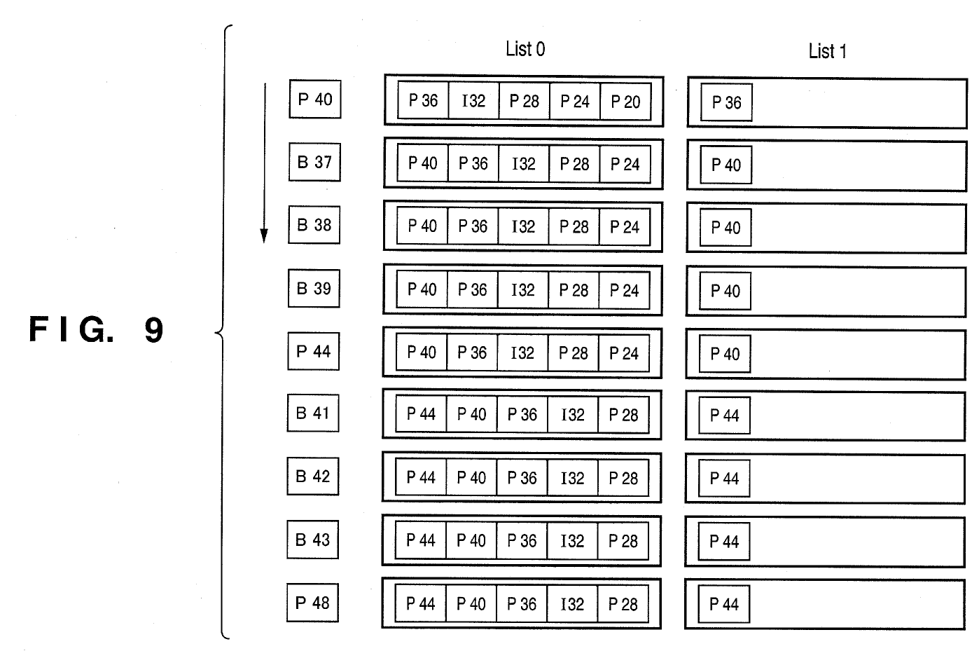

FIG. 10 is a diagram useful in describing the order of encoding in a case where B pictures are added to the reference list; and

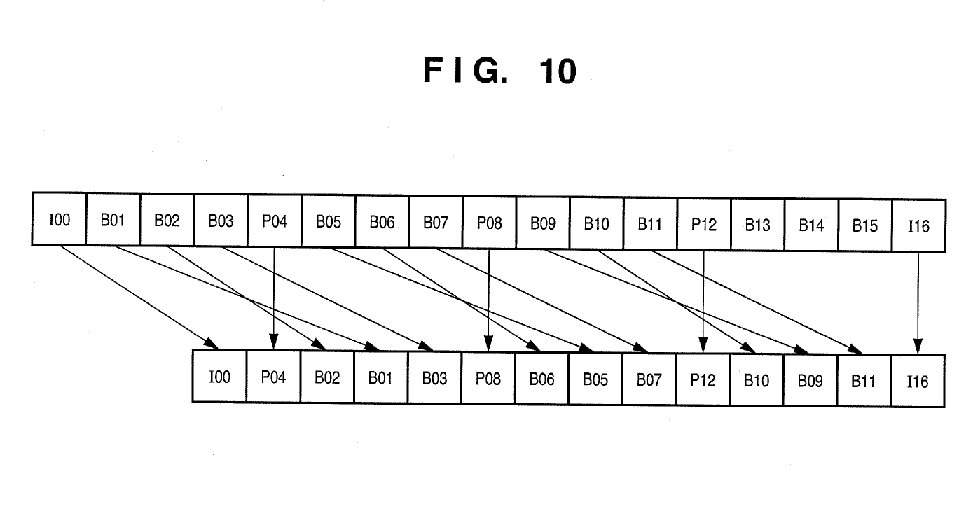

FIG. 11 is a diagram useful in describing the manner in which a reference list changes in a case where B pictures are added to the reference list.

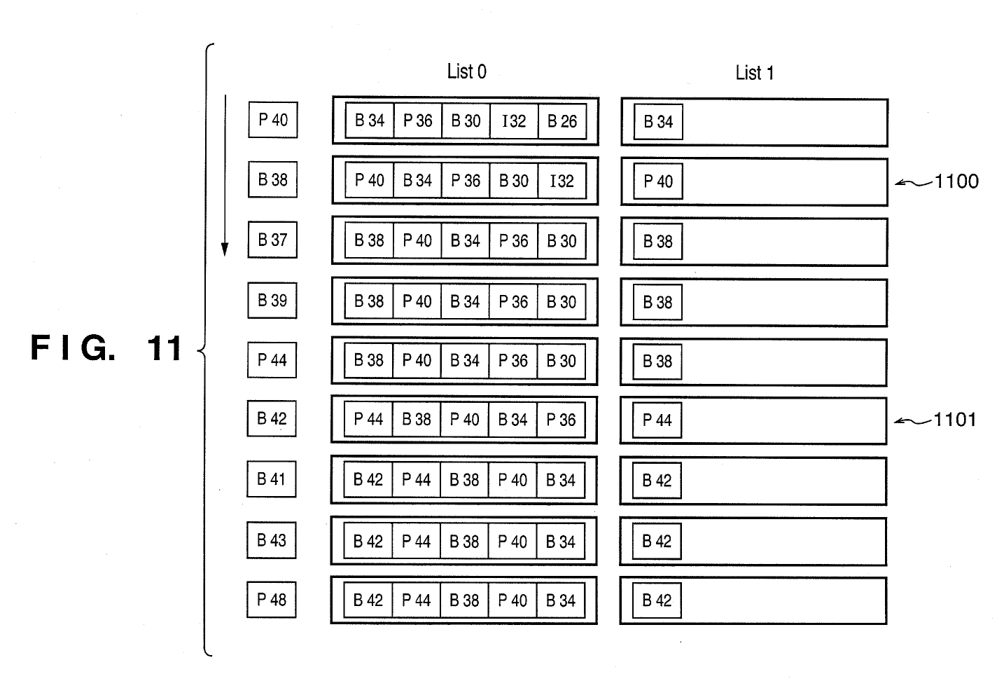

### DESCRIPTION OF THE EMBODIMENT

A preferred embodiment of the present invention will be described in detail with reference to the accompanying drawings. It should be noted that the embodiments below do not limit the present invention set forth in the claims and that all combinations of features described in the embodiments are not necessarily essential as means for attaining the objects of the invention.

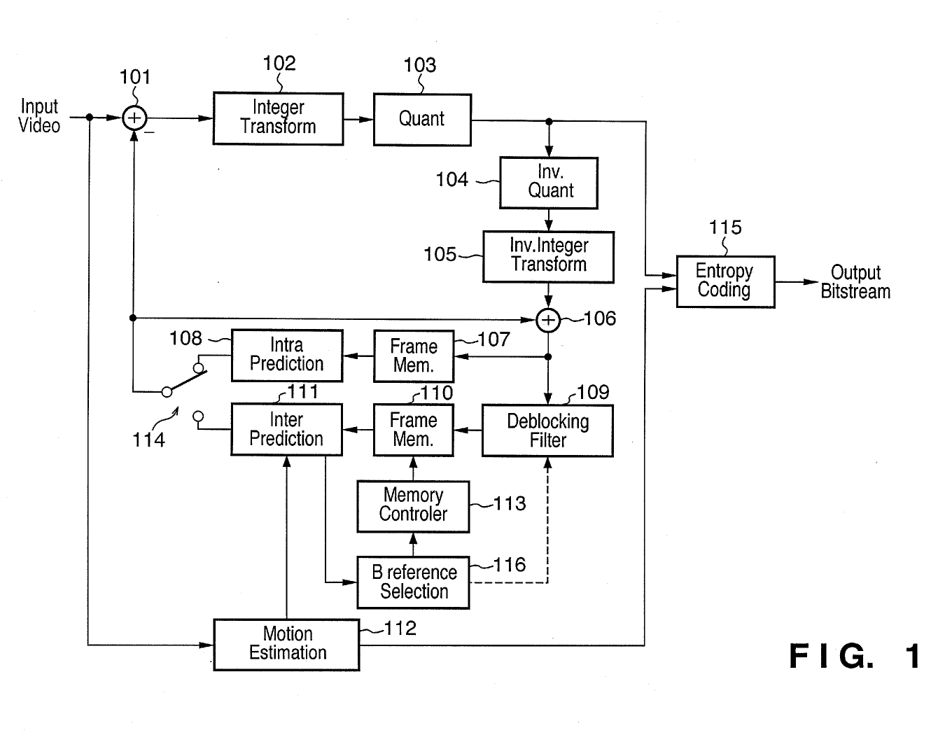

A compression procedure according to this embodiment will be described with reference to FIGS. 1 to 3. According to this embodiment, the apparatus is provided with a B reference selector having a function for selecting whether or not to add a B picture to a reference list, and whether or not a B picture is added to the reference list is capable of being changed.

FIG. 1 is a functional block diagram useful in describing the structure of an image encoding apparatus according to an embodiment of the present invention.

Image data (input video) that is input to the apparatus is image data that has been divided into macroblocks. A subtractor 101 finds the difference between the input image data and a predicted value from an intraframe prediction unit 108 or interframe prediction unit 111. A DCT unit 102 subjects the output of the subtractor 101 to an integer DCT and a quantizer 103 quantizes the result of the transform. The result of quantization is sent to an entropy encoder 115 as residual image data. The result of quantization is also subjected to inverse quantization by an inverse quantizer 104 and then to an inverse integer DCT by an inverse integer DCT unit 105. An adder 106 adds the predicted value to the result of the inverse DCT transform to thereby reconstruct the image. The image data thus restored is sent to and stored in a frame memory 107 for intraframe prediction. The image data thus reconstructed is also subjected to deblocking filtering by a filter 109, after which the data is sent to a frame memory 110 for interframe prediction.

The image data for intraframe prediction in the frame memory 107 is image data for the purpose of intraframe prediction and is used in intraframe prediction performed by the intraframe prediction unit 108. In intraframe prediction, the values of neighboring pixels of already encoded blocks in the same picture are used in making predictions. Further, as will be described later, the image data for interframe prediction in the frame memory 110 is composed of a plurality of pictures and the pictures are divided into two reference lists, namely List 0 and List 1. This image data is used in the interframe prediction unit 111. The pictures in the reference lists are updated by a memory controller 113 using the image data thus predicted. A motion estimation unit 112 detects motion and obtains an optimum motion vector in different image data from frame to frame. The optimum motion vector is applied to the interframe prediction unit 111, which then decides the predicted image data.

The optimum predicted value is selected by a switch 114 from within the image data that results from the intraframe and interframe predictions. The result from the side of the intraframe prediction or the prediction vector is sent to the entropy encoder 115. The latter encodes this together with the residual image data and produces an output bit stream. After a B picture has been encoded, a B reference selector 116 selects whether or not to add this B picture to a reference list. If the B picture is to be added to the reference list, then the B reference selector 116 informs the memory controller 113 to add the B picture to the reference list and to update the list.

The diagram of FIG. 1 is drawn in such a manner that the command from the B reference selector 116 relates only to the memory controller 113. In regard to a picture that is not added to a reference list, however the processing by the deblocking filter 109 is unnecessary. Accordingly, control may be exercised in such a manner that the output of the B reference selector 116 is input to the deblocking filter 109 so that deblocking filtering is not applied to a B picture that is not added to the reference list.

A characterizing feature of this embodiment is that whether or not a B picture is added to a reference list is selectively changed over in appropriate fashion during the course of image encoding.

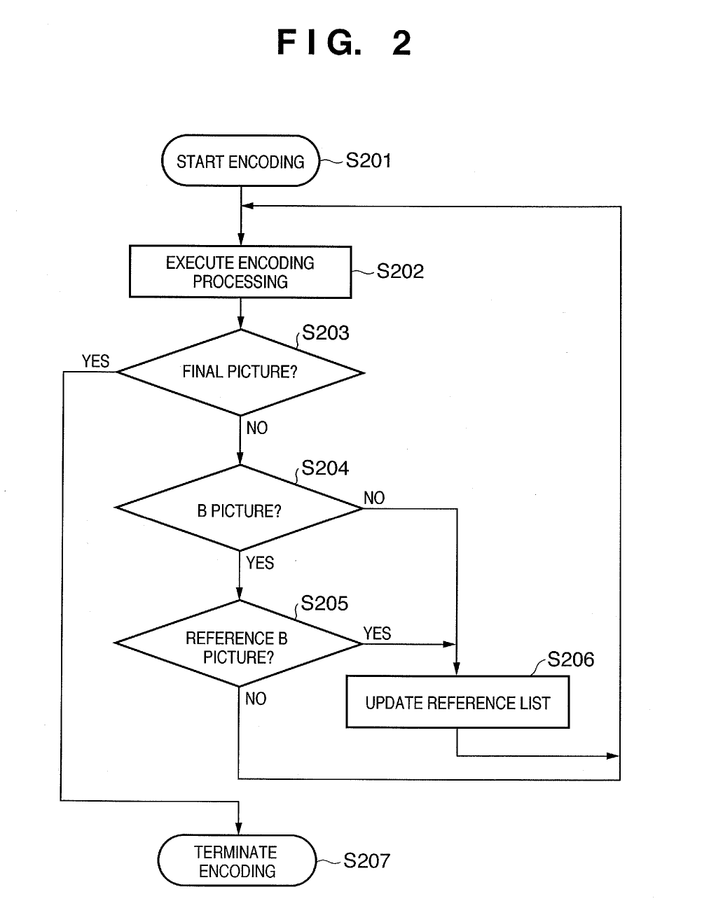

This procedure will be described with reference to the flowchart of FIG. 2.

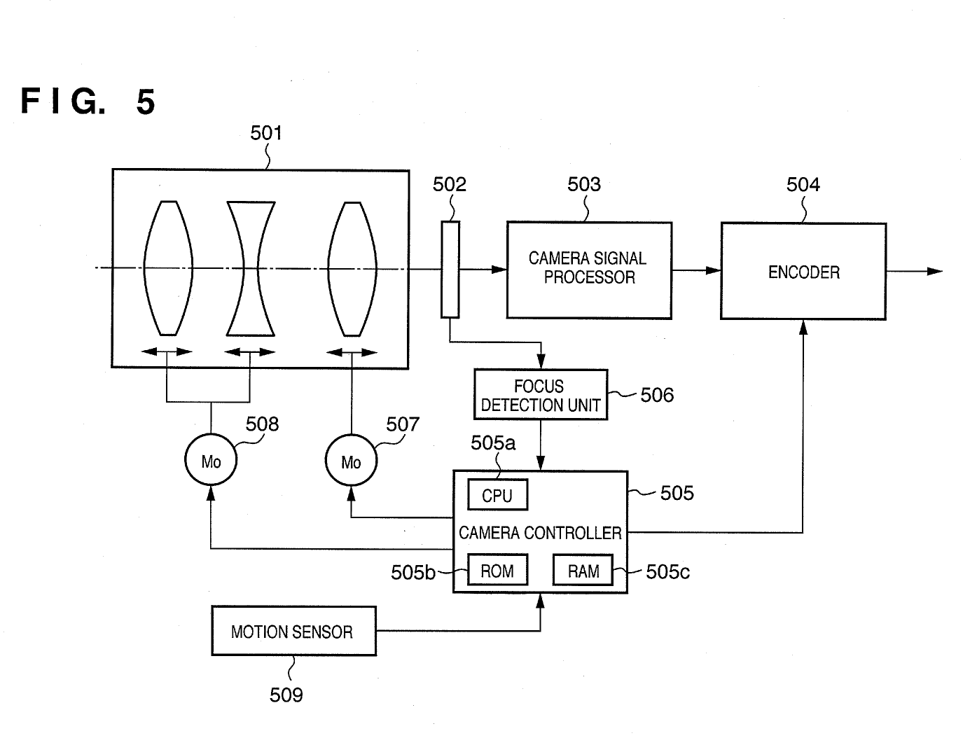

FIG. 2 is a flowchart for describing the processing of a controller that controls encoding processing by the image encoding apparatus according to this embodiment. Although a camera controller 505 (see FIG. 5) described later can be mentioned as an example of the controller, the present invention is not limited to such a camera controller.

If start of encoding is instructed at step S201 in FIG. 2, control proceeds to step S202, where encoding processing is applied to each picture. As described above with reference to FIG. 1, encoding comprises applying a DCT to residual data between input video and a predicted value, quantizing the result and applying entropy encoding, as well as performing interframe prediction, intraframe prediction and encoding by motion compensation. At step S203 that follows encoding, it is determined whether the encoded picture is the final picture. If the encoded picture is the final picture, then control proceeds to step S207 and encoding is terminated.

On the other hand, if it is determined at step S203 that the encoded picture is not the final picture, then the control proceeds to step S204, where it is determined whether to update the reference list. First, at step S204, it is determined whether the encoded picture is a B picture. If it is not a B picture, i.e., if it is an I picture or a P picture, then the control proceeds to step S206. Here the encoded I or P picture is added to the list to update the lists.

On the other hand, if the encoded picture is determined to be the B picture at step S204, then the control proceeds to step S205. Here it is determined whether or not to add this B picture to the reference list in dependence upon the results of encoding thus far and the nature of the image. If it is determined that the B picture is to be added to the reference list, the control proceeds to step S206 and the list is updated by adding the B picture. If it is determined in the step S205 that the B picture is not added to the list, the reference list is not updated and the control returns to step S202 to subject the next picture to encoding processing.

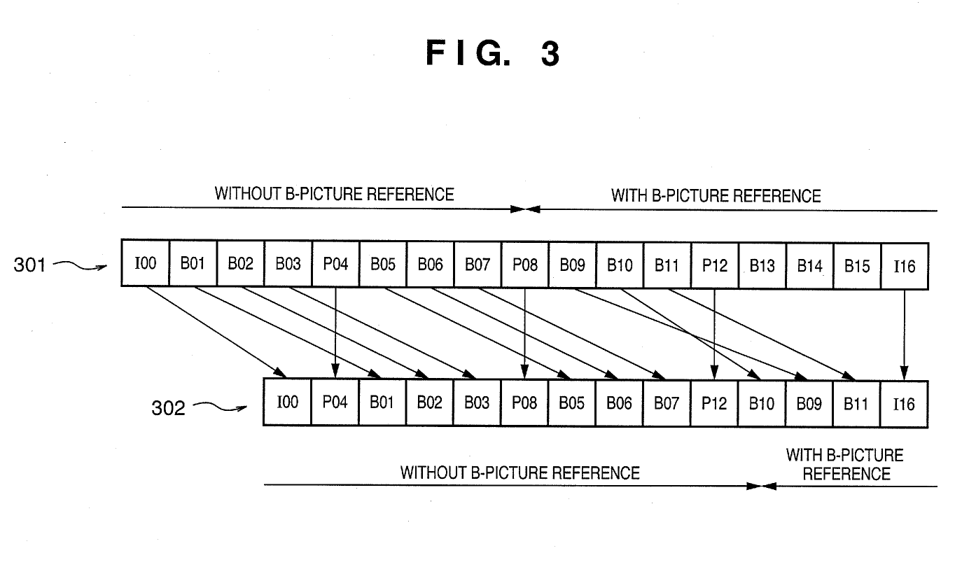

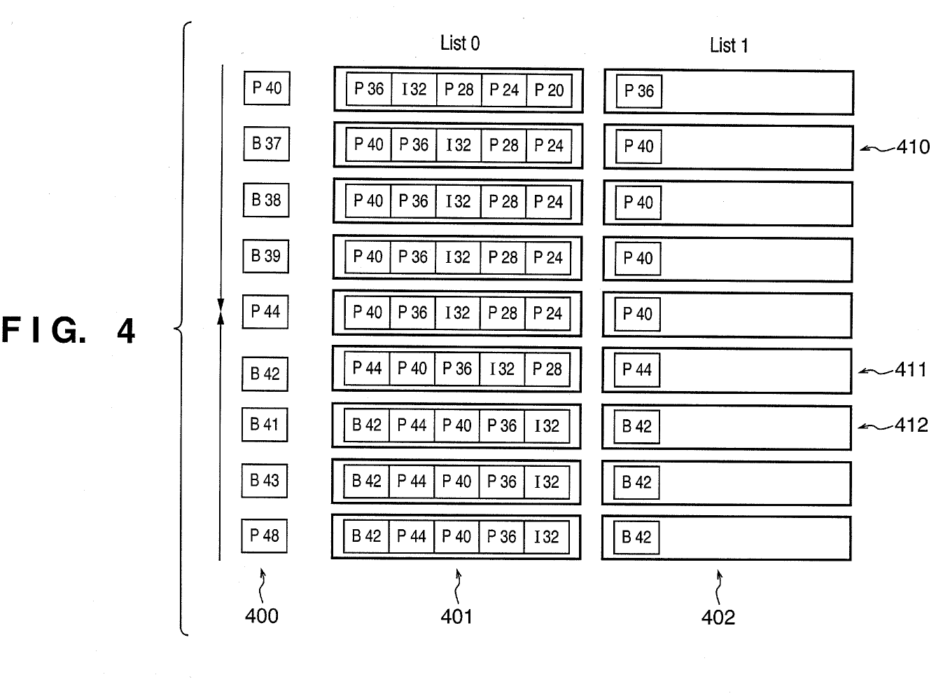

Processing for updating a reference picture according to this embodiment will be described with reference to FIGS. 3 and 4. As for the ratio of the I, P and B pictures, a case will be described where there is a standard I picture at intervals of 16 frames, a P picture at intervals of four frames and B pictures in the three frames between the I and P pictures and between the P pictures.

FIG. 3 is a diagram useful in describing a specific example of a case where it is instructed to add B pictures to a reference list during the course of encoding of pictures arrayed in the order in which they are displayed.

In FIG. 3, reference numeral 301 denotes image data arrayed in the order of display, and reference numeral 302 denotes the order of encoding. Encoding is applied from I00 (an I picture that is 0^{th} in the order of display) to I16 (an I picture that is 16^{th} in the order of display). In this example, pictures up to P08 (a picture that is eighth in the order of display) are encoded without adding B pictures to the reference list (this portion is labeled “WITHOUT B-PICTURE REFERENCE”). Pictures from P08 onward are encoded with B pictures being added to the reference list (this portion is labeled “WITH B-PICTURE REFERENCE”).

The pictures encoded first, namely pictures from I00 to P04 and P08, are encoded without B-picture reference. Next, after P12 is encoded, B09 is encoded if this is without B-picture reference. Here, however, a change has been made so as to refer to a B picture. Therefore, when B09 to B11 are encoded between P08 and P12, first B10 scheduled for use in reference is encoded and added to the reference list. This is followed by the encoding of B09 and B11. Thenceforth, and in similar fashion regarding B pictures between I and P pictures, the B picture scheduled for use in reference is encoded first and added to the reference list, then the other B pictures are encoded. For example, when B13 to B15 between P12 and I16 are encoded, first B14 scheduled for use in reference is encoded and added to the reference list, then B13 and B15 are encoded.

FIG. 4 is a diagram illustrating the manner in which a reference list is updated in a case where a change has been made so as to refer to B pictures during the course of encoding. It should be noted that at the initial stage of encoding, the reference list does not hold enough pictures and therefore the numbers of the pictures are made different from those of FIG. 3 for the sake of explanation. However, the order of the I, P and B pictures is the same as that in the example described above. in the example of FIG. 4, image data arrayed in the order of display are as follows:

P20, . . . , P24, . . . , P28, . . . , 132, . . . , P36, B37, B38, B39, P40, B41, B42, B43, P44, B45, B46, B47, P48, . . . .

FIG. 4 illustrates the manner in which the reference list changes in a time series from top to bottom. Reference numeral 400 in FIG. 4 denotes pictures to be encoded. Reference numeral 401 denotes the pictures in a reference list 0 (List 0), and reference numeral 402 denotes the pictures in a reference list 1 (List 1). In this example, the number of pictures in the reference lists is five in List 0 and one in List 1. Usually List 1 is used for backward reference of B pictures. However, if reference is had to a picture that is far removed in terms of time, a delay at the time of decoding will lengthen significantly. Ordinarily, therefore, reference is had only to one recent I or P picture. For example, if the initial P40 is encoded, reference is had from List 0 since P40 is a P picture. At this time, therefore, reference is had to P20, P24, P28, I32 and P36 in reference list 0. Following the end of encoding of P40, the reference list is updated because this is a P picture. That is, as indicated at 410 in FIG. 4, the oldest P20 in the reference list 0 is discarded and P40 is added to the list anew. Similarly, with regard to reference list 1, P36 is discarded and P40 is added to the list anew.

As a result, with regard to B37 that is the next picture, encoding is performed upon referring to P24, P28, 132 and I36 from reference list 0 and to P40 from reference list 1. Following the end of encoding of B37, the reference list is not updated because this is a B picture and reference to a B picture is not made at this time.

Next a case where reference is had to a B picture after P44 is encoded will be described. In this case, no reference is made to B pictures up to encoding of P44 in the order of display. After P44 is encoded and added to the reference list to update the list (411), what is encoded next is B42, which is scheduled to be added to the reference list, among pictures B41, B42 and B43. Following the end of encoding of B42, B42 is added to the reference lists 0, 1 and the reference lists are updated, as indicated at 412. Furthermore, the picture encoded next, namely B41, is encoded by referring to I32, P36, P40 and P44 from reference list 0 and to B42 from reference list 1. Then, in similar fashion, B43 is encoded by referring to I32, P36, P40 and P44 from reference list 0 and to B42 from reference list 1. After then further in similar fashion, P48 is encoded by referring to I32, P36, P40 and P44 from reference list 0 and to B42 from reference list 1.

In this embodiment, the encoder is provided with the B reference selector 116 and whether a B picture is to be added to a reference list is changed over selectively, as illustrated in FIG. 1. The determination to make the changeover (this corresponds to step S205 in FIG. 2) can be implemented either inside the encoder or outside the encoder.

In a case where the changeover determination is performed inside the encoder, means are provided for investigating the nature of an image (luminance level, color information, level distribution, level dispersion and frequency characteristics or combinations thereof) and the state of encoding (amount of code, values of quantization parameters, compression rate, S/N value resulting from code degradation, length of the motion vector and amount of code in the motion vector or combinations thereof), and changeover is determined from the results of these investigations. In this case, it may be so arranged that the changeover is made upon determining whether or not reference is made to a B picture during the course of encoding of a series of pictures. Alternatively, it may be so arranged that encoding is executed preliminarily before the start of processing, the nature, etc., of the image is discriminated and whether or not reference is made to a B picture is determined before the start of processing in dependence upon the result of the discrimination.

As for the case where the determination as to whether a B picture is to be added to a reference list is performed outside the encoder, if the encoder has been connected to a TV camera, as illustrated in FIG. 5, the encoder can be instructed to change the B-picture reference in accordance with the status of the camera at the time of image capturing.

FIG. 5 is a block diagram for describing the structure of an image sensing apparatus according to this embodiment.

The apparatus includes a lens unit 501, an image sensing device 502 and a signal processor 503. An encoder 504 executes the encoding processing illustrated in FIG. 1. A camera controller 505 controls the overall processing in the camera. The camera controller 505 has a CPU 505a that controls the operation of the image sensing apparatus in accordance with a program that has been stored in a ROM 505b, and a RAM 505c used as a work area for storing various data at the time of control by the CPU 505a. A focus detection unit 506 detects the in-focus state of an image. Lens actuators 507, 508 are for implementing focusing and zooming. A motion sensor 509 senses camera shake of the overall camera. The camera controller 505 ascertains the status of signals from various sensors and the operating state of lenses and instructs the encoder 504 whether or not to perform B-picture reference. It should be noted that the apparatus further includes a storage medium (e.g., a magnetic tape, memory cared, DVD, etc.) for storing image data that has been encoded by the encoder 504.

The camera controller 505 according to this embodiment stores a program, which is for executing the processing indicated in the flowchart of FIG. 2 described above, in the ROM 505b. The program is executed by the CPU 505a. By way of example, if the focus detection unit 506 has sensed that the image is out of focus, then sharpness of the image will be low and encoding easy to carry out. In the determination processing at step S205, therefore, referring to a B picture will not be effective. In this case, therefore, the camera controller 505 issues the “WITHOUT B-PICTURE REFERENCE” indication to the encoder 504. If the image is in focus, on the other hand, the image will have a high degree of sharpness and encoding will be difficult. The effectiveness of B-picture reference, however, rises. In this case, therefore, the camera controller 505 issues the “WITH B-PICTURE REFERENCE” indication to the encoder 504.

As another example, assume that camera shake is sensed by the motion sensor 509. When camera shake is sensed, the correlation between frames is low and the effectiveness of referring to B pictures is considered to be low in such case. Accordingly, the camera controller 505 issues the “WITHOUT B-PICTURE REFERENCE” indication to the encoder 504 in this case. If camera shake is not sensed, on the other hand, the camera controller 505 issues the “WITH B-PICTURE REFERENCE” indication to the encoder 504. Further, in a case where shooting is performed with a comparatively slow movement of scene, as when a camera is panned, the correlation between temporally close images is high. That is, the effectiveness of B-picture reference is great and therefore the camera controller 505 issues the “WITH B-PICTURE REFERENCE” indication.

As a further example, assume that the camera controller 505 has instructed the lens actuators 507, 508 to perform focusing or zooming. In this case, without relying upon the result of the output from the motion sensor, the camera controller 505 determines whether B-picture reference is to be performed based upon the operating decisions made during control. For example, while focusing or zooming, it is determined that the B-picture reference is not performed. Whether or not B-picture reference should be performed can thus be decided and instructed.

Thus, the determination as to whether a B picture is added to a reference list can be made based upon external conditions. In this case, whether B-picture reference is performed can be changed over based upon a change in external conditions during shooting (during encoding processing), and whether B-picture reference is performed can also be changed over based upon prevailing external conditions prior to shooting (prior to encoding processing).

Thus, in accordance with this embodiment, as described above, the encoder is provided with the B reference selector 116 and whether a B picture is added to a reference list is changed over selectively, as a result of which optimum encoding processing is realized.

It should be noted that an example in which the B reference selector 116 is provided within the encoder as an integral part thereof has been described in FIG. 1 for the sake of explanation. When this arrangement is mounted on a chip, however, this does not mean that the B reference selector 116 is incorporated within the same IC chip. Accordingly, the B reference selector 116 may be implemented on another IC chip.

The present invention can also be attained also by supplying a software program, which implements the functions of the foregoing embodiments, directly or remotely to a system or apparatus, reading the supplied program with a computer of the system or apparatus, and then executing the program. In the above-described embodiment, the program corresponds to the flowchart of FIG. 2. In this case, so long as the system or apparatus has the functions of the program, the mode of implementation need not rely upon a program.

Accordingly, since the functional processing of the present invention is implemented by computer, the program codes per se installed in the computer also implement the present invention. In other words, the claims of the present invention also cover a computer program that is for the purpose of implementing the functional processing of the present invention. In this case, so long as the system or apparatus has the functions of the program, the form of the program, e.g., object code, a program executed by an interpreter or script data supplied to an operating system, etc., does not matter.

Various recording media can be used for supplying the program. Examples are a floppy (registered trademark) disk, hard disk, optical disk, magneto-optical disk, CD-ROM, CD-R, CD-RW, magnetic tape, non-volatile type memory card, ROM, DVD (DVD-ROM, DVD-R), etc. As for the method of supplying the program, a client computer can be connected to a website on the Internet using a browser possessed by the client computer, and a download can be made from the website to a recording medium such as a hard disk. In this case, what is downloaded may be the computer program per se of the present invention or a file that contains automatically installable compressed functions. Further, implementation is possible by dividing the program codes constituting the program of the present invention into a plurality of files and downloading the files from different websites. In other words, a WWW (World Wide Web) server that downloads, to multiple users, the program files that implement the functional processing of the present invention by computer also is covered by the scope of the present invention.

Further, it is also possible to encrypt and store the program of the present invention on a storage medium such as a CD-ROM and distribute the storage medium to users. In this case, users who meet certain requirements are allowed to download decryption key information from a website via the Internet, and the program decrypted using this key information is installed on a computer in executable form.

Further, implementation of the functions is possible also in a form other than one in which the functions of the foregoing embodiment are implemented by having a computer execute a program that has been read. For example, based upon indications in the program, an operating system or the like running on the computer may perform all or a part of the actual processing so that the functions of the foregoing embodiments can be implemented by this processing.

Furthermore, it may be so arranged that a program that has been read from a recording medium is written to a memory provided on a function expansion board inserted into the computer or provided in a function expansion unit connected to the computer. In this case, a CPU or the like provided on the function expansion board or function expansion unit performs some or all of the actual processing based upon the indications in the program and the functions of the foregoing embodiments are implemented by this processing.

While the present invention has been described with reference to an exemplary embodiment, it is understood that the invention is not limited to the disclosed exemplary embodiment. The scope of the following claims is to be accorded the broadest interpretation so as to encompass all such modifications and equivalent structures and functions.

The application claims the benefit of Japanese Application No. 2005-304583 filed Oct. 19, 2005, which is hereby incorporated by reference herein in its entirety.

What is claimed is:

1. An image processing apparatus for motion-compensated predictive encoding of image data having a plurality of frames that include I, P and B pictures, comprising:
a first encoder configured to encode the I picture by intraframe prediction;
a second encoder configured to encode the P picture by referring to a reference picture;
a third encoder configured to encode a plurality of the B pictures, which exist between the I and P pictures or between the P pictures, upon referring to the reference picture after the encoding by said first and second encoders;
a decision unit configured to decide whether a pictures which has been obtained by decoding a B picture that was encoded by said third encoder, is to be used as the reference picture during the encoding of the image data; and
an updating unit configured to update the reference picture by the picture obtained by decoding the B picture, in a case that said decision unit decides that the picture obtained by decoding the B picture that was encoded by said third encoder is to be used as the reference picture.

2. The apparatus according to claim 1, wherein a plurality of the reference pictures are formed into a set to construct first and second reference lists, and motion-compensation prediction is applied to each of the reference pictures in each of the reference lists;
the P picture is subjected to motion-compensated prediction with respect to reference pictures in the first list; and
the B picture is subjected to motion-compensated prediction with respect to the first and second reference lists.

3. The apparatus according to claim 1, wherein said decision unit decides whether the decoded picture is to be used as the reference picture based upon the nature of the image data.

4. The apparatus according to claim 3, wherein the nature of the image data includes at least one among luminance, color information, level distribution, level dispersion and frequency characteristics of the image data or any combination thereof.

5. The apparatus according to claim 1, wherein said decision unit decides whether the decoded picture is to be used as the reference picture depending upon the state of encoding when the image data is compressed.

6. The apparatus according to claim 5, wherein the state of encoding includes at least one among amount of code, values of quantization parameters, compression rate, S/N value resulting from code degradation, length of a motion vector and amount of code in a motion vector, or any combination thereof.

7. The apparatus according to claim 1, wherein said image processing apparatus is an image sensing apparatus; and
said decision unit decides whether the decoded picture is to be used as the reference picture based upon any one among amount of lens movement, state of image focus and amount of spatial movement of an image sensing area, or any combination thereof.

8. An image processing method for motion-compensated predictive encoding of image data having a plurality of frames that include I, P and B pictures, comprising:
a first encoding step of encoding the I picture by intraframe prediction;
a second encoding step of encoding the P picture by referring to a reference picture;
a third encoding step of encoding a plurality of the B pictures, which exist between the I and P pictures or between the P pictures, upon referring to the reference picture after the encoding in said first and second encoding steps;
a decision step of deciding whether a picture, which has been obtained by decoding a B picture that was encoded in said third encoding step, is to be used as the reference picture during the encoding of the image data; and
an updating step of updating the reference picture by the picture obtained by decoding the B picture, in a case that it is decided in said decision step that the picture obtained by decoding the B picture that was encoded in said third encoding step is to be used as the reference picture.

9. The method according to claim 8, wherein a plurality of the reference pictures are formed into a set to construct first and second reference lists, and motion-compensation prediction is applied to each of the reference pictures in each of the reference lists;
the P picture is subjected to motion-compensated prediction with respect to reference pictures in the first list; and
the B picture is subjected to motion-compensated prediction with respect to the first and second reference lists.

10. The method according to claim 9, wherein it is decided in said decision step whether the decoded picture is to be used as the reference picture based upon the nature of the image data.

11. The method according to claim 10, wherein the nature of the image data includes at least one among luminance, color information, level distribution, level dispersion and frequency characteristics of the image data or any combination thereof.

12. The method according to claim 9, wherein it is decided in said decision step whether the decoded picture is to be used as the reference picture depending upon the state of encoding when the image data is compressed.

13. The method according to claim 12, wherein the state of encoding includes at least one among amount of code, values of quantization parameters, compression rate, S/N value resulting from code degradation, length of a motion vector and amount of code in a motion vector, or any combination thereof.

14. The method according to claim 9, wherein said image processing method is implemented by an image sensing apparatus; and
it is decided in said decision step whether the decoded picture is to be used as the reference picture based upon any one among amount of lens movement, state of image focus and amount of spatial movement of an image sensing area, or any combination thereof.
